(19) United States
(12) Patent Application Publication
(10) Pub. No.: US 2026/0292285 A1
(43) Pub. Date: Sep. 24, 2026

(54) TECHNIQUES FOR NETWORK CONGESTION CONTROL

(71) Applicant: NETFLIX, INC., Los Gatos, CA (US)

(72) Inventor: Paul-Louis Serge Daniel AGENEAU, Amsterdam (NL)

(21) Appl. No.: 19/272,731

(22) Filed: Jul. 17, 2025

Related U.S. Application Data
(60) Provisional application No. 63/773,978, filed on Mar. 18, 2025.

(51) Int. Cl. H04N 21/2662; H04N 19/172; H04N 21/262

(52) U.S. Cl. CPC H04N 21/2662; H04N 19/172; H04N 21/2625

(57) ABSTRACT

A computer-implemented technique for controlling network congestion includes determining a first slope that relates (i) reception durations over which packets are received by a client device and (ii) send durations over which packets are transmitted to the client device; interpolating a first send duration over which packets are transmitted to the client device and a first reception duration over which packets are received by the client device based on the first slope to determine a second send duration; and causing one or more first packets to be transmitted over a network based on the second send duration.

### CROSS-REFERENCE TO RELATED APPLICATIONS

This application claims priority benefit of the United States Provisional Patent Application titled, “TECHNIQUES FOR NETWORK CONGESTION CONTROL,” filed on Mar. 18, 2025, and having Ser. No. 63/773,978. The subject matter of this related application is hereby incorporated herein by reference.

### BACKGROUND

### Field of the Invention

The contemplated embodiments relate generally to computer science and streaming and video processing technologies and, more specifically, to techniques for network congestion control, including all of the hardware, software, and algorithms relevant to implementing all systems, functions, and operations contemplated herein.

### Description of the Related Art

In computer networking, packets of data are transmitted through a series of interconnected devices (also referred to herein as “nodes” or “network nodes”), such as routers and switches, from a source computer to a destination computer. For example, to transmit a video over a network, each frame of the video could be encoded at the source computer, and the encoded frame could then be split into data packets that are transmitted from the source computer through a number of network nodes to the destination computer.

Network congestion occurs when a link or a node on a network path is unable to handle the packet traffic being transmitted through that link or node. The limiting link or node is referred to as a bottleneck. Network congestion can cause packets being transmitted through the network to be delayed or can even result in packets failing to reach a desired destination computer.

One approach for mitigating the effects of network congestion is for a destination computer to store received packets temporarily in a jitter buffer and then play back the buffered packets at a constant rate. Buffering received packets gives delayed packets an opportunity to arrive at the destination computer and then be played back along with other packets that have not been delayed. One drawback of buffering packets in this fashion is that storing received packets in a jitter buffer and then playing back the stored packets can introduce playback delay. Some applications, such as cloud gaming applications, require real-time data and cannot tolerate the playback delay caused by buffering packets.

As the foregoing illustrates, what is needed in the art are more effective techniques for mitigating network congestion.

### SUMMARY OF THE EMBODIMENTS

One embodiment of the present disclosure sets forth a computer-implemented method for controlling network congestion. The method includes determining a first slope that relates (i) reception durations over which packets are received by a client device and (ii) send durations over which packets are transmitted to the client device. The method further includes interpolating a first send duration over which packets are transmitted to the client device and a first reception duration over which packets are received by the client device based on the first slope to determine a second send duration. In addition, the method includes causing one or more first packets to be transmitted over a network based on the second send duration.

Other embodiments of the present disclosure include, without limitation, one or more computer-readable media including instructions for performing one or more aspects of the disclosed techniques as well as a computing device for performing one or more aspects of the disclosed techniques.

At least one technical advantage of the disclosed techniques relative to the prior art is that the disclosed techniques do not require buffering packets and, therefore, do not cause playback delay when packets are being played back. Another technical improvement over prior art approaches is that the disclosed techniques enable adjustment of the send duration for each frame based on an estimated share of available network path capacity, which provides a relatively accurate estimate of network capacity and reduces queuing. The disclosed techniques also enable transmission rate control based on measured send and reception durations along with additional feedback indicating whether packet transmission should be reduced due to congestion. The additional feedback improves responsiveness in changing network conditions and enables more accurate identification of a most restrictive network bottleneck. In addition, the disclosed techniques enable alignment of transmitted frames with the display interval expected by a client device and modification of transmission timing in response to changes in frame size and delivery delay. These technical advantages represent one or more technological advancements over prior art approaches.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a conceptual illustration of a system that is configured to implement one or more aspect of the various embodiments;

FIG. 2 is a more detailed illustration of the server of FIG. 1, according to various embodiments;

FIG. 3 is a more detailed illustration of the client device of FIG. 1, according to various embodiments;

FIG. 4A illustrates how the congestion control module of FIG. 1 controls network congestion, according to various embodiments;

FIG. 4B is a more detailed illustration of the congestion control module of FIG. 1, according to various embodiments;

FIG. 5 illustrates an exemplar linear regression using packet send duration information and packet receive duration information, according to various embodiments;

FIG. 6 illustrates how the capacity estimator of FIG. 1 computes an estimated network path capacity, according to various embodiments;

FIG. 7 is a schematic diagram illustrating frame alignment delay compensation, according to various embodiments;

FIG. 8 is a flow diagram of method steps for adaptive pacing via slope-based interpolation, according to various embodiments;

FIG. 9 is a flow diagram of method steps for computing an effective slope, according to various embodiments;

FIG. 10 is a flow diagram of method steps for frame-alignment delay compensation, according to various embodiments; and

FIG. 11 is a flow diagram of method steps for computing a target bitrate and encoding frames based on the target bitrate, according to various embodiments.

### DETAILED DESCRIPTION

As described, conventional congestion control techniques rely on triggering short network congestion events and require client devices to buffer received packets in a jitter buffer to mitigate packet delay or loss. However, interactive real-time applications such as cloud gaming require the shortest end-to-end transmission delay and cannot tolerate the playback delay caused by buffering packets in a jitter buffer. Further, conventional congestion control techniques increase the transmission rate too slowly for applications that require high bitrate. In addition, when video frames are encoded at a source computer and split into data packets for transmission through network nodes to a client device, conventional techniques require an encoder to meet a particular target bitrate, which the encoder may not achieve when content complexity varies.

The disclosed techniques control network congestion by dynamically adjusting both packet emission pacing and encoder bitrate to suit real-time application requirements. In some embodiments a congestion control module within a transport stack of the server estimates available network path capacity by dithering send durations and performing a linear regression on (1) send durations over which packets associated with encoded frames are transmitted and (2) corresponding reception durations over which packets are received, in order to compute a slope. The congestion control module approximates the intersection of a regression line with the identity line y=x as a limit to compute a capacity estimated bitrate. In parallel, the congestion control module applies an additive-increase/multiplicative-decrease (AIMD) technique to packet-loss and Explicit Congestion Notification (ECN) feedback to derive a congestion control bitrate. The congestion control module then selects a minimum of the capacity estimated and congestion control bitrates as a final target bitrate and a minimum of the capacity estimated slope and a congestion control slope derived from the congestion control bitrate as an effective slope for determining a pacing rate for a pacer. The pacer interpolates between a jittered probe send duration and a reception-target send duration according to the effective slope to generate a per-frame send interval, and the encoder encodes frames to match the target bitrate. In addition, the pacer can delay the transmission of packets for a given frame to compensate for variations caused by both network conditions and frame size fluctuations so that the last packets of frames arrive each frame period, yielding stable frame delivery.

Although described herein with respect to packets associated with encoded frames as a reference example, in some other embodiments, the unit of measurement with respect to which send and reception durations are measured can be any suitable group of packets, such as the packets associated with a frame, a group of frames, a part of a frame, or something else (e.g., when a real-time media other than video, such as a real-time virtual reality, is transmitted).

Advantageously, the disclosed techniques address various limitations of conventional approaches for mitigating network congestion. More specifically, the disclosed techniques do not require a jitter buffer and, therefore, do not cause playback delay when packets are being played back. In addition, the disclosed techniques can adjust the send duration for each frame based on an estimated share of available network path capacity, yielding a relatively accurate capacity estimate and reducing queuing. The disclosed techniques further can quickly adapt transmission rate which improves responsiveness to changing network conditions and enables more accurate identification of network bottlenecks. Finally, the disclosed techniques align transmitted frames with the display interval expected by a client device and modify transmission timing in response to changes in frame size and delivery delay.

### System Overview

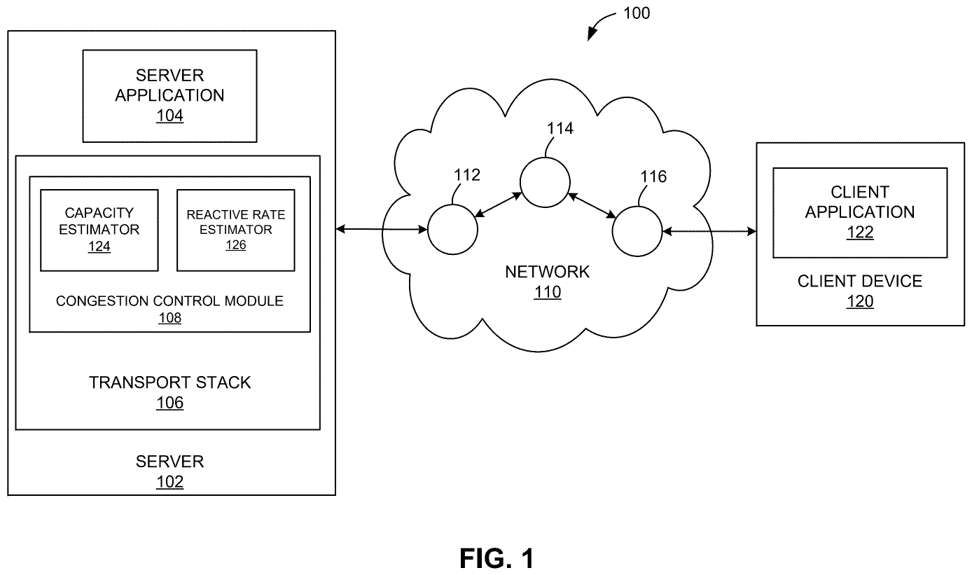

FIG. 1 is a conceptual illustration of a system 100 that is configured to implement one or more aspects of the various embodiments. As shown, the system 100 includes a server 102 and a client device 120 that communicate over a network 110, such as the Internet. Illustratively, communication between the server 102 and the client device 120 traverses a network path that includes a number of nodes, shown as nodes 112, 114, and 116. Each of the nodes 112, 114, and 116 can be a router or a switch in some embodiments.

A server application 104 running in the server 106 serves data to a client application 122 running in the client device 120. For example, in some embodiments, the server application 104 can be a cloud gaming application that serves video and audio data for a gaming session and receives user inputs from the client application 122. More generally, a server application, such as the server application 104, can serve any suitable data to one or more client applications. For example, in some other embodiments, the server application can be a telephone, videoconference, telepresence (e.g., a camera filming an operation performed remotely), virtual reality, musical collaboration, ultra-low-latency live streaming, or real or virtual device remote control application.

The client application 122 can be a web browser or any other technically feasible software application that is capable of interacting with the server application 104. Returning to the cloud gaming example, the client application 122 can be a dedicated application for playing cloud-based video games.

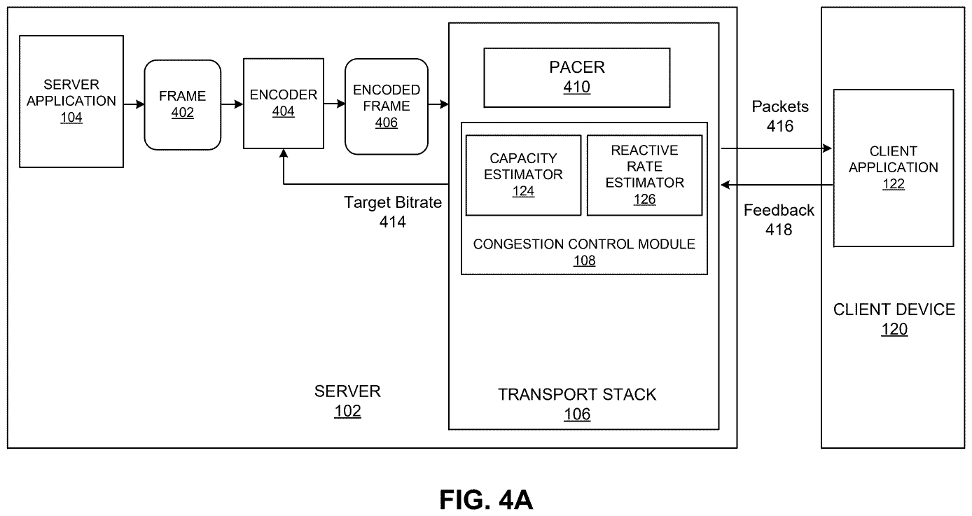

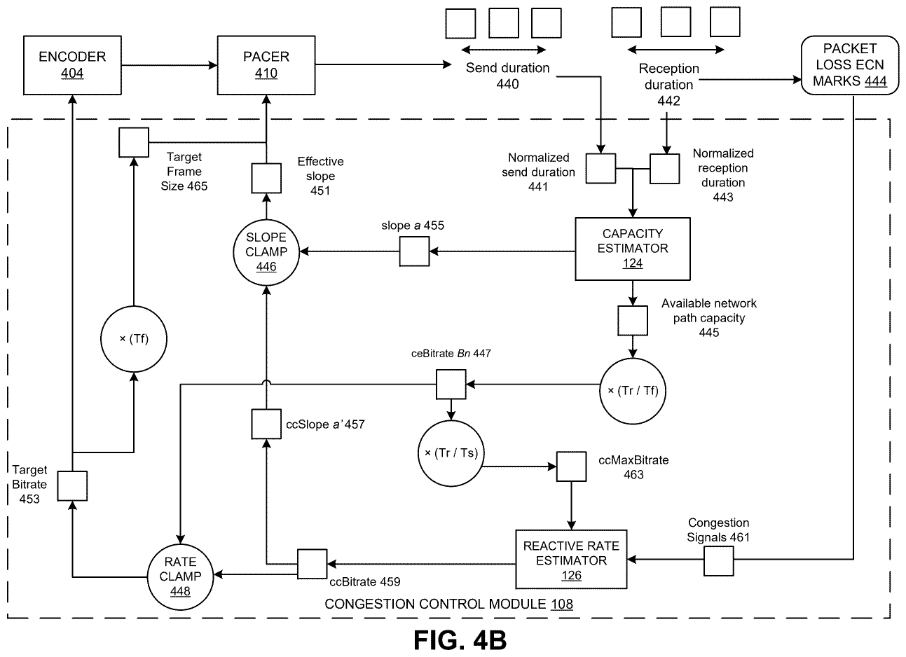

In order to control network congestion when the server application 104 is transmitting packets to the client application 122 over the network 110 (and over the network path that includes the nodes 112, 114, and 116 in particular), a congestion control module 108 in a transport stack 106 of the server 102 is configured to (1) determine an available capacity of the network path that includes the nodes 112, 114, and 116; and (2) cause an encoder to encode frames for transmission at a target bitrate and a pacer to transmit packets at a pacing rate based on the available network capacity, as discussed in greater detail below in conjunction with FIGS. 4A-10. Doing so can ensure that the packets associated with encoded frames are able to arrive at the client device 120 in time for decoding with a comfortable safety margin, i.e., that packet delay and packet loss are avoided.

The congestion control module 108 includes, without limitation, a capacity estimator 124 and a reactive rate estimator 126. The capacity estimator 124 applies a linear regression to normalized send durations and reception durations for encoded-frame packets in order to estimate a slope and an available network path capacity, as discussed in greater detail in conjunction with FIGS. 4A and 4B.

The reactive rate estimator 126 applies an additive-increase/multiplicative-decrease (AIMD) technique to packet-loss and Explicit Congestion Notification (ECN) feedback in order to derive a congestion control bitrate, from which a corresponding congestion control slope can be computed, as discussed in greater detail in conjunction with FIGS. 4A and 4B.

The slope and the bitrate determined using the capacity estimator 124 and the reactive rate estimator 126 are input into a slope-clamp module and a rate-clamp module, respectively that merge the capacity-based and congestion control-based results. The slope-clamp module selects a minimum pacing slope for adaptive packet pacing. The rate-clamp module selects a minimum bitrate for encoder target bitrate, as discussed in greater detail in conjunction with FIGS. 4A and 4B.

As described, while packets associated with encoded frames are used herein as a reference example, in some other embodiments, the unit of measurement with respect to which send and reception durations are measured can be any suitable group of packets, such as the packets associated with a frame, a group of frames, a part of a frame or something else (e.g., when a real-time media other than video, such as a real-time virtual reality, is transmitted).

For explanatory purposes only, one server 102, one client device 120, and three nodes 112, 114, and 116 of the network 110 are shown in FIG. 1. However, as persons skilled in the art will recognize, a system may generally include any number of servers, client devices, and network nodes, and the servers, client devices, and network nodes may run on one or more physical computing systems or virtual computing systems running in, e.g., a data center or cloud. Further, functionality of the servers, client devices, and network nodes may be distributed across any number of other computing devices, or functionality of any number of applications may be consolidated into a single application or subsystem.

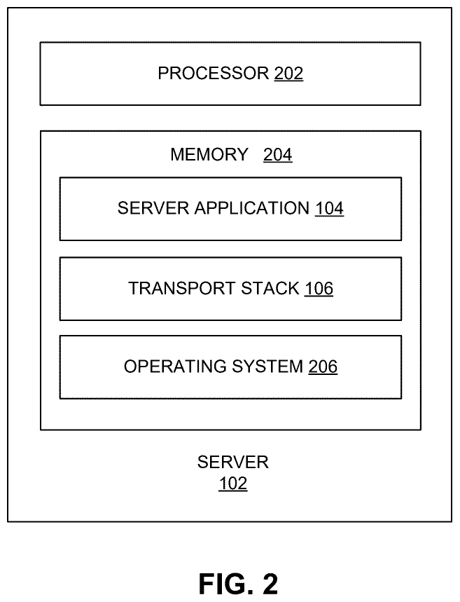

FIG. 2 is a more detailed illustration of the server 102 of FIG. 1, according to various embodiments. As shown, the server 102 includes, without limitation, a processor 202 and a memory 204. The processor 202 can be any instruction execution system, apparatus, or device capable of executing instructions. For example, the processor 202 could comprise a central processing unit (CPU), a graphics processing unit (GPU), a controller, a microcontroller, a state machine, or any combination thereof. The memory 204 stores content, such as software applications and data, for use by the processor 202.

The memory 204 can be one or more of a readily available memory, such as random access memory (RAM), read only memory (ROM), floppy disk, hard disk, or any other form of digital storage, local or remote. In some embodiments, a storage (not shown) may supplement or replace the memory 204. The storage may include any number and type of external memories that are accessible to the processor 202. For example, and without limitation, the storage may include a Secure Digital Card, an external flash memory, a portable compact disc read-only memory (CD-ROM), an optical storage device, a magnetic storage device, or any suitable combination of the foregoing.

As shown, the memory 204 stores the server application 104, the transport stack 106, and an operating system 206 on which the server application 104 and the transport stack 106 run. The operating system 206 may be, e.g., Linux®, Microsoft Windows®, or Android™. Each of the server application 104 and the transport stack 106 can be a service, application, or other type of software that runs on or is included in the operating system 206. Functionality of the server application 104 and the transport stack 106 can also be distributed across multiple pieces of software in some embodiments.

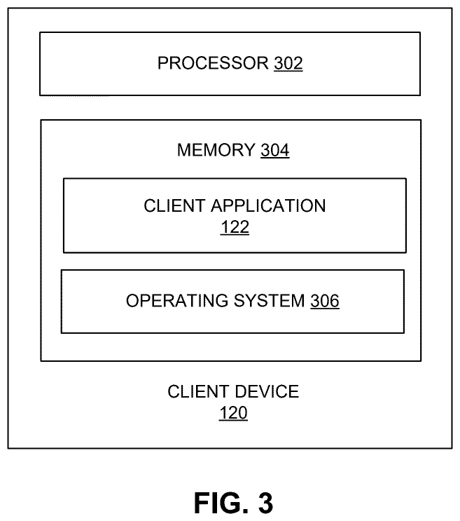

FIG. 3 is a more detailed illustration of the client device 120 of FIG. 1, according to various embodiments. As shown, the client device 120 includes a processor 302 and a memory 304, which may perform similar functionalities as the processor 202 and the memory 204, respectively, of the server 102 described above in conjunction with FIG. 2. In some embodiments, a storage (not shown) may supplement or replace the memory 304. As shown, the memory 304 stores the client application 122 that is in communication with the server application 104 via the network 110 and an operating system 306 on which the client application 122 runs, which in some embodiments can be similar to the operating system 206 described above in conjunction with FIG. 2.

### Network Congestion Control

FIG. 4A illustrates how the congestion control module of FIG. 1 controls network congestion, according to various embodiments. As shown, the server 102 includes, without limitation, the server application 104, an encoder 404, and the transport stack 106. The transport stack 106 includes, without limitation, a pacer 410 and the congestion control module 108. The congestion control module 108 includes, without limitation, the capacity estimator 124 and the reactive rate estimator 126.

In operation, the server application 104 generates frames, shown as frame 402, that are transmitted to the client application 122. For example, the server application 104 could be a cloud gaming application that generates the frames of a video game and transmits the frames in real time to the client application 122. In such cases, the real time transmission can require that the frames be transmitted in the shortest achievable amount of time, which is oftentimes no more than a few tens of milliseconds (ms). Although sometimes described herein with respect to cloud gaming applications as a reference example of real-time applications, techniques disclosed herein can be used with any suitable applications, including other real-time application such as telephone, videoconference, telepresence (e.g., a camera filming an operation performed remotely), virtual reality, musical collaboration, ultra-low-latency live streaming, and real or virtual device remote control applications. Some cloud gaming, telepresence, virtual reality, musical collaboration, ultra-low-latency live streaming, and real or virtual device remote control applications can be highly interactive and are, therefore, more time-critical, as a user can perceive any input lag as a lack of responsiveness for actions/reactions, which users are generally very sensitive to. By contrast, for some “conversational” applications, such as phone/video conferencing applications, users can be relatively tolerant to delays, which appear as gaps between speakers.

The encoder 404 encodes frames to generate corresponding encoded frames. Illustratively, the encoder 404 encodes the frame 402 to generate an encoded frame 406. The encoder 404 can perform any technically feasible encoding operations, based on any suitable encoding parameters, in some embodiments. In particular, the encoder 404 can encode frames at a particular bitrate, which can correspond to a particular frame size of each encoded frame. The encoder 404 passes encoded frames, such as the encoded frame 406, to the transport stack 106 for transmission over a network, such as the network 110 described above in conjunction with FIG. 1.

The transport stack 106 provides end-to-end communication services for applications, including the server application 104. In particular, the transport stack packetizes encoded frames (e.g., encoded frame 406) and transmits the packets to client devices (e.g., client device 120). As shown, the transport stack 106 includes the pacer 410 and the congestion control module 108 that includes the capacity estimator 124 and the reactive rate estimator 126.

The pacer 410 sends packets, into which each encoded frame n is split, to the client application 122 in one or more bursts, over a variable per-frame send duration Sn. In some embodiments, the per-frame send duration can be implemented by varying a pacer deadline by which the burst(s) of packets associated with each encoded frame need to have left the pacer 410. In such cases, the pacer 410 will send an encoded frame on a packet-by-packet basis (B=1) or on a burst-by-burst basis (B>1) so that the last packet is sent out just before the deadline is reached:

$${K}_{n} = ⌊ \frac{\vert {P}_{n} \vert + B - 1}{B} ⌋ , \qquad ( 1 )$$

$${I}_{n} = ⌊ \frac{{S}_{n}}{max \{ {K}_{n} , 2 \}} ⌋ , \qquad ( 2 )$$

where |Pₙ| is a number of packets, B is the burst size in packets (an integer) and Sn is the per-frame send duration over which the packets associated with an encoded frame are transmitted. At each time internal Iₙ, the pacer 410 transmits B packets from the queue, meaning the packets for an entire encoded frame can be transmitted under Sₙ. In some other embodiments, the per-frame send duration can be implemented with a more traditional rate-based pacer waiting before or after sending each packet for a duration proportional to the packet size such as the whole frame is sent over Sₙ.

In order to probe the available network path capacity, the target frame reception duration Tᵣ must be higher than a base send duration Tₛ, thereby creating a positive feedback loop that can probe for higher and higher network path capacities until the network path bottleneck capacity is reached:

$${T}_{r} > {T}_{s} . \qquad ( 3 )$$

For example, in a design where the frame period is

$${T}_{f} = \frac{1}{30} seconds ,$$

such as in the case of some cloud gaming applications, the send duration Tₛ and the target reception duration Tᵣ can be set to Tₛ=10 ms and Tᵣ=2Tₛ=20 ms, in which case the pacer 410 will attempt to pace at twice the target bitrate. Accordingly, in this example, the network path capacity can be measured up to twice the previously estimated capacity, and the transmission rate can be increased multiplicatively until the network path capacity is reached, without risk of overshooting the network path capacity. In some other embodiments, different settings can be used to obtain different multiplicative bounds on the increase of transmission rate.

In some embodiments, the pacer 410 computes a dithered per-frame send duration Sₙ over which to send the packets for a given encoded frame by adding a random variation Δ to the base send duration and then applying adaptive pacing via a slope-based interpolation.

$${S}_{n} = {a}_{eff} * ( {T}_{s} \pm Δ ) + ( 1 - {a}_{eff} ) \cdot {T}_{r} \qquad ( 4 )$$

For example, if the uniform random noise is set to Δ=0.5 Ts, then with Ts=10 ms, the send duration will vary between 5 ms and 15 ms.

In Equation 4, a_{eff} (0≤a_{eff}≤1) is the effective slope that is determined as a minimum of (1) a slope computed by the capacity estimator 124 and (2) a slope computed from a congestion control bitrate output by the reactive rate estimator 126, as discussed in greater detail below in conjunction with FIG. 4B. As per Equation 4, when a_{eff}→1, the pacer probes aggressively (sends close to the base send duration Tₛ±Δ); when a_{eff}→0, the pacer backs off toward the target reception duration Tr. That is, according to Equation 4, the pacer 410 will send packets closer to the reception rate Tᵣ so that the pace is close to available capacity when the effective slope a_{eff} is closer to 0, and the pacer 410 will send packets over a duration around the base send duration Ts when the effective slope a_{eff} is closer to 1. Accordingly, if the capacity estimation by capacity estimator 124 indicates to not pace faster because a network bottleneck is being hit, the capacity estimation will be followed even if the congestion control indicates that the pacing can be faster. In practice, when a congestion control situation is encountered (e.g., due to a limitation with a link in the network path), the congestion control bitrate will drop, changing the slope because the maximum congestion control bitrate is higher. As the slope goes to 0, the pacer 410 will pace slower and slower until the pacer 410 is pacing at a slope 0, i.e., at the target bitrate. Thereafter, the slope will stay at 0 and the target bitrate will be reduced to follow the pacer, and vice versa if the congestion control situation is alleviated. Accordingly, typically during ramp up, the effective slope will be close to 1, and the send duration may be close to the base send duration plus the random variation. However, the pacer 410 will begin to interpolate according to Equation 4 when a bottleneck is encountered.

In addition, in some embodiments, if the encoded frame 406 is smaller than the target size, then the pacer 410 reduces the send duration to compensate for the smaller encoded frame 406. Such a compensation is required because frames smaller than the target size would otherwise be transmitted at a pace that is slower than the pace at which frames matching the target size are transmitted. As a result of the slower pace of transmission, an available network path capacity can be measured as artificially lower and result in degraded quality when the content becomes more dynamic. By scaling down the send duration linearly to compensate for smaller frames, the sending rate of packets associated with the smaller frames are unaffected by the smaller sizes of the frames.

In some embodiments, the variable send duration, over which the packets for an encoded frame are sent, can be computed as:

$${S}_{n} = [ {a}_{eff} * ( {T}_{s} \pm Δ ) + ( 1 - {a}_{eff} ) * {T}_{r} ) ] \times min ( \frac{Frame size}{Target size} , 1 ) , \qquad ( 5 )$$

where Ts is a base send duration, ±Δ is a uniform random noise for dithering, and

$$\frac{Frame size}{Target size}$$

is the compensation ratio to maintain the send rate when an encoded frame size is smaller than the target size.

After encoded frames are sent to the client application 122, the congestion control module 108 receives, from the client application 122, the feedback 418. In some embodiments, the feedback 418 can indicate a reception duration for packets associated with each encoded frame. In some embodiments, the feedback 418 can specify (1) acknowledgements of packets that were received by the client application 122, and (2) timings of when the packets were received, which the client application 122 aggregates and transmits to the server 102 as feedback information. In some embodiments, the feedback 418 can also specify (3) congestion signals, such as packet-loss or ECN marks for use by the reactive rate estimator 126.

The congestion control module 108 infers the current network condition and updates a target bitrate 414 at which the encoder 404 encodes frames. In some embodiments, the target bitrate is determined as a minimum of a congestion control bitrate determined by the reactive rate estimator 126 using an AIMD technique and a fraction of an available network path capacity determined by the capacity estimator 124. Calculation of the target bitrate 414 is discussed in greater detail below in conjunction with FIG. 4B.

FIG. 4B is a more detailed illustration of the congestion control module 108 of FIG. 1, according to various embodiments. As shown, the congestion control module 108 includes, without limitation, the capacity estimator 124, the reactive rate estimator 125, a slope clamp module (“slope clamp”) 446, and a rate clamp module (“rate clamp”) 448. In operation, the congestion control module 108 combines capacity-based estimates from the capacity estimator 126 with a reactive additive increase/multiplicative decrease (AIMD)-style rate adjustments of the reactive rate estimator 126 to compute both a pacing slope, shown as effective slope 451, and a target bitrate, shown as target bitrate 453. In a given encode-and-send cycle, the encoder 404 passes encoded frames to pacer 410, which emits packet bursts with send duration 440 and reception duration 442 recorded for each encoded frame. In parallel, packet-loss and ECN-mark feedback 444 is collected from a previous cycle.

In FIG. 4B, two major paths exist, the first path being a capacity estimation path involving the capacity estimator 124 and the second path being a reactive rate estimation path involving the reactive rate estimator 126. As described, the congestion control module 108 combines capacity-based estimates from the capacity estimator 126, which is the first path, with reactive AIMD-style rate adjustments of the reactive rate estimator 126, which is the second path, to compute both a pacing slope (e.g., effective slope 451), and a target bitrate (e.g., target bitrate 453).

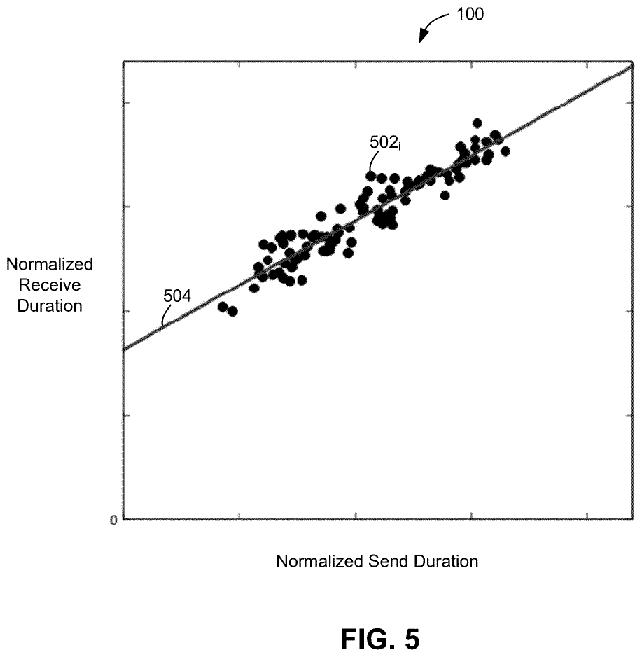

In the first path involving capacity estimation via the capacity estimator 124, send duration 440 and reception duration 442 are each divided by the corresponding frame size to yield a normalized send duration 441 and a normalized reception duration 443, respectively, as discussed in greater detail below in conjunction with FIG. 5 and Equation 8. In some embodiments in which a linear relationship (i.e., a line) is determined relating the send duration (x) and reception duration (y), the capacity estimator 124 determines an available network path capacity 445 as an estimated intersection between the computed line and the line y=x, which is a linear relationship representing a normalized send duration and a normalized reception duration being equal. It should be understood that the available network path capacity 445, as determined by the capacity estimator 124, is the capacity of a bottleneck node in the network path between the server 102 and the client device 120. In some embodiments, the capacity estimator 124 computes an estimate of the available network path capacity 445 by approaching the intersection of the determined line with the line y=x as a limit.

After the capacity estimator 124 computes the available network path capacity 445 in the capacity estimation path, the congestion control module 108 computes a capacity estimated bitrate Bₙ ceBitrate 447 based on a fraction of the available network path capacity 445. In some embodiments, the ceBitrate 447 can be calculated as:

$$ceBitrate = \frac{{T}_{r}}{{T}_{f}} C \qquad ( 6 )$$

where T_{f} is the frame period, Tᵣ is the target reception duration for a frame Tᵣ<T_{f}, C denotes the estimated available network path capacity.

By setting the ceBitrate 447 according to Equation 6, frames can be given time to arrive at the client device 120 while keeping some leeway to accommodate for network variability and unexpected events. In addition, the ceBitrate 447 can converge relatively quickly based on the estimated available network path capacity.

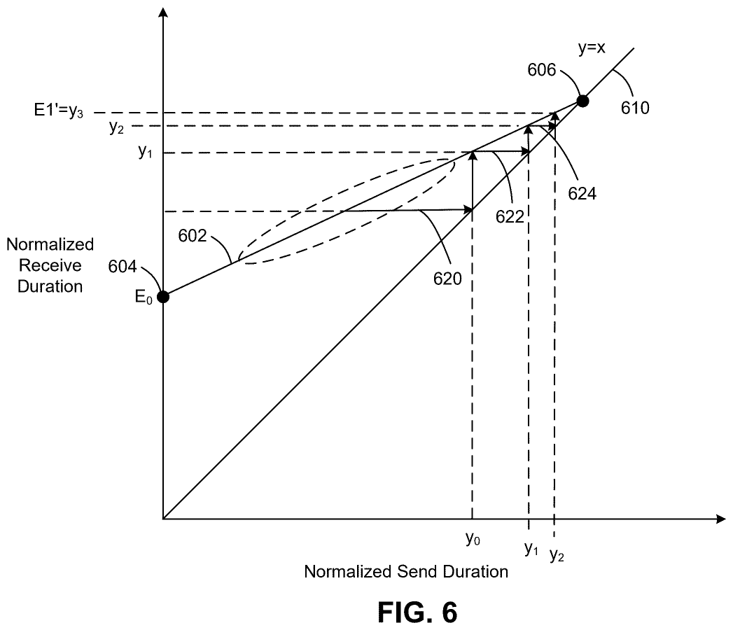

In some embodiments, the capacity estimator 124 applies an exponentially weighted moving average process to the normalized send durations (e.g., normalized send duration 441) and reception durations (e.g., normalized reception duration 443). Capacity estimator 124 computes a regression slope a 455 (e.g., capacity-estimated slope) and γ-intercept b for the line y=a·x+b, where x represents normalized send duration and y represents normalized reception duration. These coefficients capture the dependence between emission pacing and observed throughput without requiring storage of historical measurements. Steps for computing the regression slope and intercept are discussed in greater detail below in conjunction with FIG. 6 and associated Equations 9-12.

Capacity estimator 124 iteratively extrapolates the regression line toward the intersection of ordinate E₁ with the identity line y=x, thereby estimating a normalized receive duration at the receive-rate operating point. Available capacity C is calculated as 1/E₁. Capacity estimator 124 multiplies C by the ratio of the reception target Tr to the frame period Tf to produce the ceBitrate 447, such that frames encoded at the ceBitrate 447 rate will occupy only a fraction Tr/Tf of the available path capacity.

As described, the second major path is the reactive rate estimation path involving the reactive rate estimator 126. In some embodiments, the reactive rate estimator 126 applies an AIMD technique in response to packet-loss or ECN-mark feedback. The reactive rate estimator 126 outputs a congestion control bitrate (ccBitrate) 459, and the congestion control module 108 derives a secondary slope (congestion-control slope ccSlope) a′ 457 by mapping the ccBitrate 459 against a rate-scaling factor Tr/Ts, where Ts is a send-interval target duration (i.e., the minimum pacing duration) chosen to probe the path capacity.

$$ccMaxBitrate = \frac{T r}{T s} \times ceBitrate \qquad ( 7 A )$$

Tr is the target reception duration per-frame, set larger than Ts but smaller than frame period Tf, ensuring a safety margin. The reactive rate estimator must factor in the maximum rate that congestion signaling can allow, relative to the pacing configuration. The rate clamp 448 ensures the ccBitrate 459 remains capped at the maximum bitrate ceBitrate 447 produced by capacity estimator 124. In some embodiments, the congestion control module 108 maps the ccBitrate 459 to slope a′ 457 according to Equation 7B.

$${a}^{′} = max ( 1 - \frac{ceBitrate}{ccMaxBitrate} - 1 , 0 ) / ( 1 - \frac{{T}_{s}}{{T}_{r}} ) \qquad ( 7 B )$$

In some embodiments, packet loss ECN marks 444 aggregate two standard congestion signals 461. The first signal includes packet-loss events reported by the client application 122, for example by detecting missing sequence numbers in the received packets or retransmission requests. The second signal includes ECN-CE (Explicit Congestion Notification-Congestion Experienced) flags set by routers to indicate incipient queue buildup. The reactive rate estimator 126 applies a classic AIMD logic using the two signals. On receipt of any packet-loss event or ECN-CE flag, the reactive rate estimator 126 multiplies a congestion control bitrate (ccBitrate) by a factor β below unity and suppresses additive increase for one round-trip interval. In the absence of congestion signals 461, the reactive rate estimator 126 adds a constant α to the congestion bitrate up to a configured maximum, ccMaxbitrate 463.

In some other embodiments, ECN signals are instead interpreted in the modified form used by the Low Latency, Low Loss, and Scalable Throughput (L4S) Internet service. On receipt of ECN-CE flags, the reactive rate estimator reacts similarly to a standard Prague congestion control scheme and makes the multiplicative decrease and additive increase depend on the moving average of ECN feedback.

Accordingly, the two major paths include (1) the capacity estimator computing the slope a 455 and the available network path capacity 445, from which the ceBitrate 447 can be computed; and (2) the reactive rate estimator 126 computing the ccBitrate 457, from which the ccSlope a′ 457 can be computed.

Slope clamp 446 receives two input slopes: the regression slope a 455 from the capacity estimator 124 and the ccSlope a′ 457 that is computed from the ccBitrate 459 output by the reactive rate estimator 126. The slope clamp 446 selects the minimum of the regression slope a 455 and the ccSlope a′ 457 as the effective slope 451. The pacer 410 obtains the effective slope 451 from the slope clamp 446 and applies the effective slope 451 during adaptive pacing, described above in conjunction with FIG. 4A. By interpolating send-interval values according to the effective slope, the pacer 410 ensures that pacing never exceeds the limits indicated by the capacity estimation by the capacity estimator 124 or the AIMD backoff by the reactive rate estimator 126.

The rate clamp 448 receives two input bitrates: the capacity estimated bitrate ceBitrate 447 computed based on the available capacity output by the capacity estimator 124 (and equal to available capacity×Tr/Tf) and the congestion control bitrate ccBitrate 459 from the reactive rate estimator 126. The rate clamp 448 selects the minimum of these two bitrates to produce a target bitrate, shown as the target bitrate 453.

The encoder 404 receives the target bitrate 453 from the rate clamp 448. The encoder 404 encodes each new frame to produce a frame size approximating (target bitrate x Tf) bytes, ensuring that frame emission matches the clamped rate of the target bitrate 453.

During the transmission of packets, the pacer 410 uses a target frame size 465 value that is computed by multiplying the target bitrate 453 and the frame period Tf.

The pacer 410 uses the target frame size 465 when applying undersized-frame compensation (scaling of per-frame send duration by FrameSize/TargetSize) to maintain consistent pacing behavior even when the encoder 404 output undershoots a desired target

FIG. 5 illustrates an exemplar linear regression using packet send duration information and packet receive duration information, according to various embodiments. As shown, given send duration data that is provided by the pacer 410 and receive duration data that is computed from feedback information provided by the client application 122, the congestion control module 108 normalizes the send duration data and the receive duration data to obtain normalized send duration data and normalized receive duration data, respectively:

$${r}_{n} = \frac{{S}_{n}}{{L}_{n}} , {s}_{n} = \frac{{R}_{n}}{{L}_{n}} . \qquad ( 8 )$$

where Ln is the size of packetized frame n obtained by summing up the size of packets:

$${L}_{n} = {\sum }_{i ∈ {P}_{n}} Size ( i ) .$$

In some embodiments, the send duration data and the receive duration data are normalized per byte to account for frame sizes changing over time because of both target bitrate changes and encoder variability. The normalized send duration and normalized reception duration are passed to capacity estimator 124 to calculate the available network capacity and slope a, as discussed in conjunction with FIG. 4B and below.

After the send duration data and the receive duration data are normalized and provided to the capacity estimator 124, the capacity estimator 124 performs linear regression to fit a line 504 to points 502 (referred to herein collectively as points 502 and individually as a point 502) of the form (sₙ, rₙ) (I.e., normalized send duration, normalized receive duration). Notably, when packets are sent faster, for example back-to-back in a burst at the sender, the measured network path capacity will be closer to a total capacity of the network path, because the packets will be less affected by cross-traffic on the network path interleaving between the packets. By contrast, when packets are sent slowly, for example evenly paced over some period of time at the sender, the measured network path capacity will be closer to an available share of the capacity of the network path, because the packets can be affected by cross-traffic on the network path interleaving between the packets. More precisely, the proportion of cross-traffic packets that become interleaved with the sender traffic affects the reception duration so as to cause a linear dependency between send duration and reception duration.

FIG. 6 illustrates how the capacity estimator 124 of FIG. 1 computes an estimated network path capacity, according to various embodiments. As shown, graphically, an intercept 604 of the line 602 with the y-axis, which is denoted by E₀=b, corresponds to the hypothetical normalized reception duration when a frame is sent as a single burst, which is equal to the reciprocal of the total capacity of the network path between the server 102 and the client device 120 if the bottleneck capacity is reached. In addition, an intercept 606 of the line 602 with identity, i.e., the line y=x 610, which is denoted by E₁, corresponds to a normalized reception duration when sending at the reception rate, meaning the packet flow uses its own network capacity share, which can be used to estimate the available network path capacity as the reciprocal of the available capacity of the network path. By performing a linear regression to determine the line 602, the capacity estimator 124 can extrapolate what the reception duration (i.e., the total capacity or throughput) would be if packets were sent as fast as possible (i.e., the send duration is 0) and if packets were sent close to the reception rate, without actually sending packets as fast as possible or at the reception rate. In particular, the total capacity of a network path can be computed as

$$\frac{1}{{E}_{0}} ,$$

and the available capacity of a network path C can be computed as

$$C = \frac{1}{{E}_{1}} .$$

In particular, for a line given by y=ax+b with a<1, E₁ can be computed as

$${E}_{1} = \frac{b}{1 - a} .$$

In some embodiments, in order to determine the line 602 more efficiently than performing a linear regression, the capacity estimator 124 can compute the linear coefficients with an exponentially weighted moving average (EWMA) dual-variable process. It should be noted that the EWMA can be computed online using new send and reception durations, which is less computationally expensive than storing send and reception durations and then performing a full-fledged linear regression using the stored send and reception durations. More formally, for a line given by y=ax+b, since

$$Cov ( x , y ) = Cov ( x , a x + b ) = a Cov ( x , x ) = a Var ( x ) , a = \frac{Cov ( x , y )}{Var ( x )} \qquad ( x )$$

and
b=Avg(y)−aAvg(x). Accordingly, the linear coefficients a and b can be estimated by leveraging the EWMA process to estimate Avg(x), Avg(y), Var(x), and Cov(x, y).

In some embodiments, the capacity estimator 124 also computes an estimate of the available network path capacity by approaching the intersection 606 of the line 602 that relates the normalized send duration (x) to the normalized reception duration (y) with the line y=x 610 as a limit. Approaching the intersection with the line y=x 610 as a limit is beneficial when the slope of the line 602 is close to or equal to 1, such as during ramp-up when the reception duration is substantially equal to the send duration. In such cases, the line 602 may not intersect the line y=x 610, meaning that

$${E}_{1} = \frac{b}{1 - a}$$

becomes undefined. Approaching the intersection as a limit is robust to such cases.

To approach the intersection 606 of the line 602 with the line y=x 610 as a limit, the capacity estimator 124 first sets the send duration to an average reception duration. Then, the capacity estimator 124 iteratively (1) computes a reception duration associated with the set send duration, and (2) sets the send duration to the computed reception duration, with the capacity estimator 124 returning at each iteration to compute another reception duration associated with the set send duration. For example, in some embodiments, the capacity estimator 124 can iterate for a few (for example three or four) iterations in which steps (1) and (2), described above, are performed during each iteration. Then, the capacity estimator 124 can set the estimated available network path capacity to the last computed reception duration.

More formally, in some embodiments, the capacity estimator 124 first sets the send duration to an average reception duration

$${y}_{0} = A v g ( y ) . \qquad ( 9 )$$

Then, the capacity estimator 124 iteratively (1) computes a reception duration associated with the set send duration, and (2) sets the send duration to the computed reception duration, as follows:

$${y}_{n + 1} = a {y}_{n} + b . \qquad ( 10 )$$

It should be understood that the limit is the intersection if defined:

$$lim {y}_{n} = {E}_{1} if a < 0. \qquad ( 11 )$$

Further, the available network path capacity can be set as

$$C = \frac{1}{{y}_{n}} , \qquad ( 12 )$$

where N is a number of iterations, shown as 3 iterations in FIG. 6.

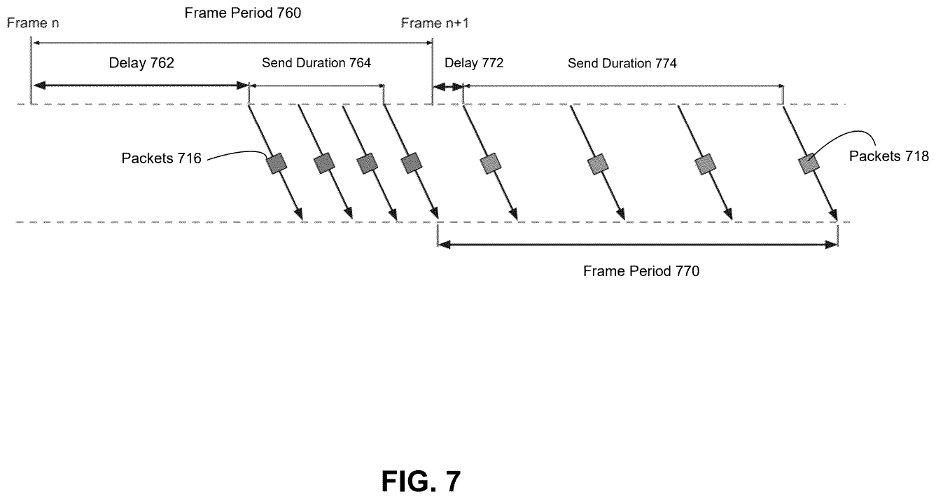

FIG. 7 is a schematic diagram illustrating frame alignment delay compensation, according to various embodiments. As shown, a frame period 760 includes a delay 762 and a send duration 764, and a frame period 770 includes a delay 772 and a send duration 774.

Packets 716 and 718 are emitted by the pacer 410 (not shown) into the network during the send duration 764 and the send duration 774, respectively. Specifically, the pacer 410 dequeues the packets 716 and 718 for a given frame and transmits the packets 716 and 718 from the transport stack 106 toward the client device 120.

Each frame period 760 and 770 corresponds to the interval between successive frame emissions and equals the reciprocal of a media frame rate. A frame period has time length Tf, and, for example, can be set to 1/30 seconds for a thirty-frame-per-second stream or to 1/60 seconds for a sixty-frame-per-second stream.

A delay (e.g., delay 762 or 772), denoted as Dn, can be calculated according to equation 13 with (0≤a_{eff}≤1), Ts being a base send duration, A being a uniform random variation, and Sₙ being the per-frame send duration for a given frame.

$${D}_{n} = {a}_{e f f} ( {T}_{s} + Δ - {S}_{n} ) \qquad ( 13 )$$

A send duration (e.g., send duration 764 or 774) is denoted as Sₙ and represents the interval over which the packets of a given frame are emitted by the pacer 410. A send duration is constrained to lie within the jitter-dithered bounds Sₙ ∈[Ts−Δ, Ts+Δ]. Adaptive pacing logic, as previously discussed, determines Sₙ based on the slope a_{eff} so that pacing moves aggressively when a_{eff}→1 and backs off toward a safe target when a_{eff}→0. That is, the packer 410 introduces, before sending the first packet for a frame, a delay is the effective slope times the maximum send duration (i.e., Tₛ+Δ) minus the send duration Sₙ.

Packets (e.g., packets 716 or 718) are generated from an encoded frame and are dequeued by the pacer 410 and transmitted over the network 110 during a send duration (e.g., send duration 764 or 774). In some embodiments, packet emission is performed in bursts or individual transmissions such that the last packet of each frame exits the pacer 410 immediately before the end of Sₙ.

A reception duration Rn is measured at the client and fed back to the capacity estimator 124. Under a linear regression model, Rₙ relates to Sₙ according to

$$\frac{{R}_{n}}{{L}_{n}} = a \frac{{S}_{n}}{{L}_{n}} + b \qquad ( 14 )$$

where Lₙ is the size of the packetized frame n. The knowledge of both Sₙ and Rₙ for a frame n enables the capacity estimator 124 to update the linear regression parameters a and b, and thereby refine subsequent pacing and encoding decisions, as described above in conjunction with FIGS. 4A-6.

Within a given frame period (e.g., frame period 760 or 770), the delay (e.g., delay 762 or 772) precedes the send duration 764 to ensure that the last packet of frame n arrives at the client application 122 as close as possible to the nominal frame-period boundary. Without such a delay, variations in send duration (due to dithered probing) can cause the final packet of each frame to arrive at unpredictable times, introducing decoding jitter and requiring a larger de-jitter buffer at the client. The pacer 410 introduces a delay to compensate for variations so that the last packets of a given frame are guaranteed to land before the arrival window of the next frame, yielding stable frame delivery.

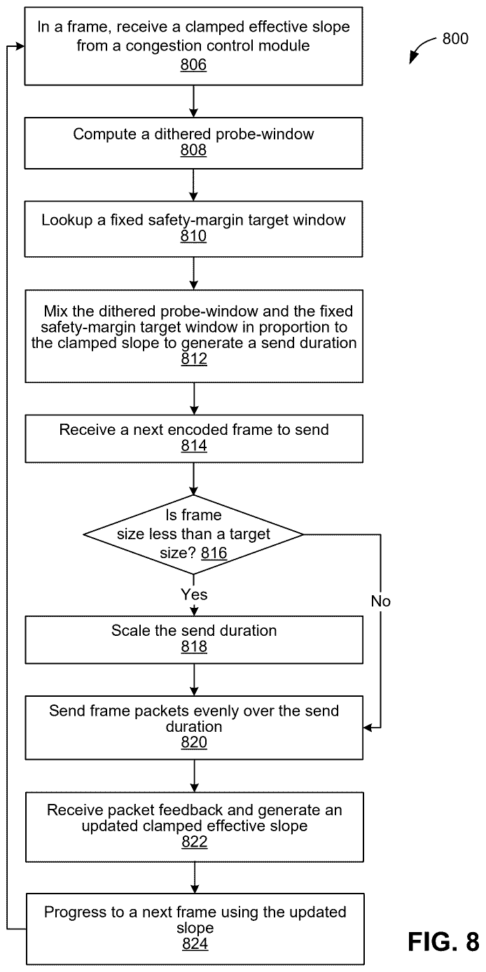

FIG. 8 is a flow diagram of method steps for adaptive pacing via slope-based interpolation, according to various embodiments. Although the method steps are described with reference to the systems of FIGS. 1-7, persons skilled in the art will understand that any system configured to implement the method steps, in any order, falls within the scope of the present disclosure.

As shown, a method 800 begins at step 806, where the congestion control module 108 provides a clamped effective slope value for frame pacing. In some embodiments, the clamped slope represents a minimum of a capacity-based slope from a capacity estimator 124 and a congestion-based slope from a reactive rate estimator 126, as described in conjunction with FIGS. 4A-4B.

At step 808, the pacer 410 computes a dithered probe-window by adding random variation to a base send duration. The dithered probe-window supports capacity estimation by dithering packet emission over successive frames, as described in Equation 4.

At step 810, the pacer 410 looks up a fixed safety-margin target window. The safety-margin target window corresponds to a reception duration that provides a leeway margin for decoding at the client without inducing late frames, as described above in conjunction with FIG. 4A.

At step 812, the pacer 410 interpolates the probe-window and the fixed safety-margin target window in proportion to the clamped slope to compute a send duration. The interpolation defines a per-frame send duration Sn that can be used for packet pacing, as described above in conjunction with FIG. 4.

At step 814, the transport stack 106 receives a next encoded frame from the encoder 404 for transmission.

At step 816, the congestion control module 108 compares the actual size of the encoded frame to the target frame size 465. If the actual frame size is smaller, the method proceeds to step 818; otherwise, the method 800 progresses to step 820.

At step 818, the pacer 410 scales down the per-frame send duration Sn in proportion to the ratio of actual frame size to target frame size 465, as described above in conjunction with FIGS. 4A-4B. This compensation preserves the normalized pacing rate when the encoder 410 undershoots the target.

At step 820, the pacer 410 instructs packet emission by spreading frame packets evenly over the final send duration Sn.

At step 822, when the client application 122 returns packet feedback that is received by the congestion control module 108, the capacity estimator 124 computes an updated clamped effective slope via online regression, as described above in conjunction with FIGS. 5-6.

At step 824, the congestion control module 108 updates the clamped effective slope for the next frame and returns to step 806 to repeat the adaptive pacing loop.

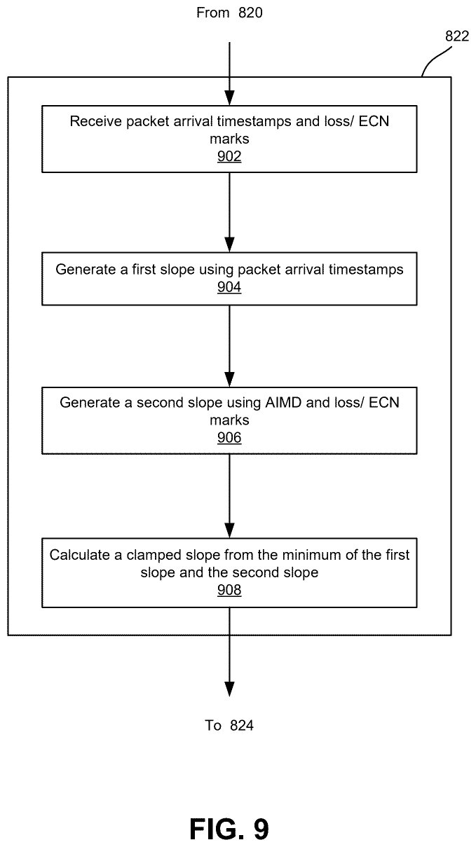

FIG. 9 is a flow diagram of method steps for computing an effective slope at step 822 of the method 800, according to various embodiments. Although the method steps are described with reference to the systems of FIGS. 1-7, persons skilled in the art will understand that any system configured to implement the method steps, in any order, falls within the scope of the present disclosure.

As shown, at step 902, the congestion control module 108 receives, as part of feedback 418, packet arrival timestamps and congestion signals 461, in addition to packet loss indications and ECN marks 444.

At step 904, the capacity estimator 124 processes the packet arrival timestamps to generate a first slope, a, that reflects the relationship between normalized send duration and normalized reception duration using an online regression, as described above in conjunction with FIG. 4B.

At step 906, the reactive rate estimator 126 applies an AIMD technique to the packet loss indications and ECN marks 444 to generate a second slope, a′, that governs rate back-off in response to congestion signals 461.

At step 908, the slope clamp 446 computes a clamped effective slope, a_{eff}, as the minimum of the first slope a and the second slope a′. The clamped effective slope Jeff, serves as the effective pacing slope passed to the pacer 410 for a subsequent per-frame send duration calculation (step 812 of FIG. 8).

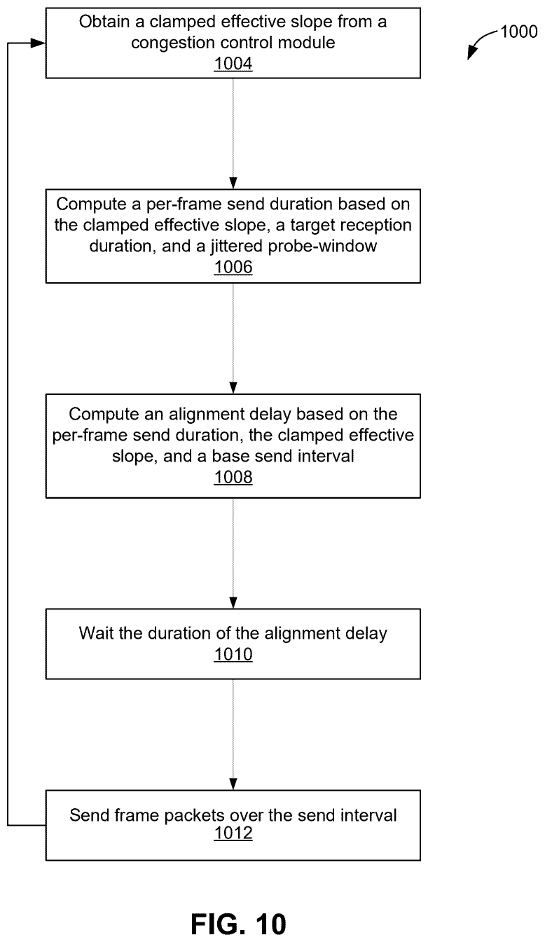

FIG. 10 is a flow diagram of method steps for frame-alignment delay compensation, according to various embodiments. Although the method steps are described with reference to the systems of FIGS. 1-7, persons skilled in the art will understand that any system configured to implement the method steps, in any order, falls within the scope of the present disclosure.

As shown, a method 1000 begins at step 1004, where the congestion control module 108 obtains a clamped effective slope, computed by the slope clamp 446 based on the slopes output by the capacity estimator 124 and computed from the congestion control bitrate output by the reactive rate estimator 126 of the congestion control module 108, as described above in conjunction with FIG. 4B.

At step 1006, the congestion control module 108 computes a per-frame send-duration, Sₙ, by combining the clamped effective slope a_{eff}, the target reception duration Tᵣ, and a dithered probe-window around a base send duration, Tₛ, as described above in conjunction with FIGS. 4A and 7.

At step 1008, the congestion control module 108 computes an alignment delay, Dn, as described above in conjunction with FIG. 7 based on the per-frame send duration, the base send duration, the per-frame send duration, and the dithered probe-window.

At step 1010, the congestion control module 108 delays emission of the first packet by Dₙ before instructing the pacer 410 to send packets.

At step 1012, the pacer 410 sends all packets associated with frame n evenly over the send-interval Sₙ. The method then returns to step 902 to process the next frame using an updated clamped effective slope.

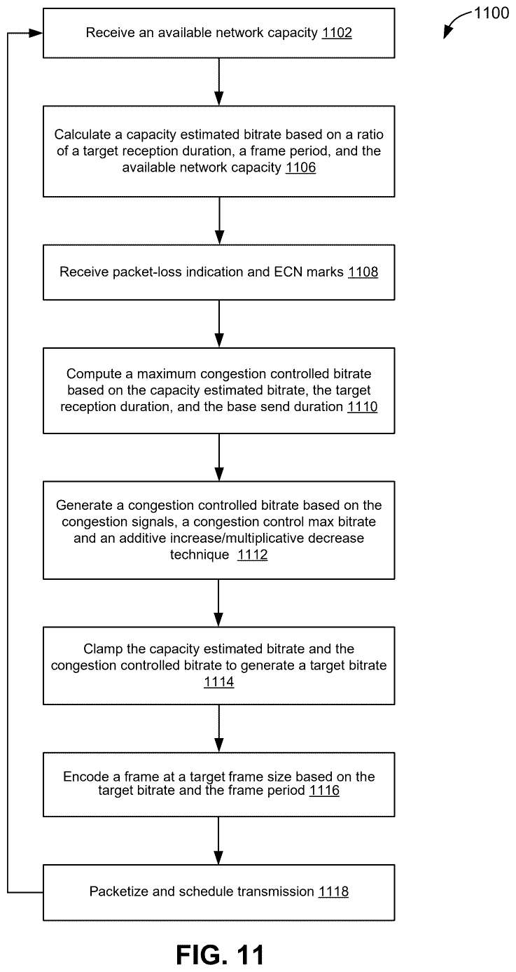

FIG. 11 is a flow diagram of method steps for computing a target bitrate and encoding frames based on the target bitrate, according to various embodiments. Although the method steps are described with reference to the systems of FIGS. 1-7, persons skilled in the art will understand that any system configured to implement the method steps, in any order, falls within the scope of the present disclosure.

As shown, a method 1100 begins at step 1102, where the congestion control module 108 receives an available network path capacity C, from the capacity estimator 124, as described above in conjunction with FIG. 6.

At step 1106, the congestion control module 108 calculates a capacity estimated bitrate, ceBitrate, as described above in conjunction with FIG. 4B, based on the ratio of the target reception duration Tᵣ to the frame period T_{f}, and the available network capacity.

At step 1108 the reactive rate estimator 126 receives packet-loss indications and ECN marks as part of feedback 418 from the client device 120.

At step 1110 the congestion control module 108 computes a maximum congestion bitrate, ccMaxBitrate 463, as the product of the capacity estimated bitrate and a ratio of the target reception duration, Tr, and the base send duration Ts, as described above in conjunction with FIG. 4B.

At step 1112 the reactive rate estimator 126 computes a congestion control bitrate, ccBitrate, using congestion signals 461 and the ccMaxBitrate 463 by applying an AIMD technique that multiplicatively reduces the current bitrate by a factor upon detection of a congestion signal and then, in the absence of further signals and after one round-trip interval, additively increases the bitrate by an increment, as described above in conjunction with FIG. 4B.

At step 1114, the congestion control module 108 clamps, via the rate clamp 448, the capacity estimated bitrate ceBitrate and the congestion control bitrate to generate a target bitrate.

At step 1116, the congestion control module 108 computes a target frame size 465 by multiplying the target bitrate by the frame period TF.

At step 1118, the transport stack 106 packetizes the encoded frame and schedules packet transmission via the pacer 410 over the send duration Sₙ. The method 1100 then returns to step 1002 to process a subsequent frame using updated capacity and loss inputs.

In sum, the disclosed techniques control network congestion by dynamically adjusting both packet emission pacing and encoder bitrate to suit real-time application requirements. In some embodiments a congestion control module within a transport stack of the server estimates available network path capacity by performing a linear regression on (1) send durations over which packets associated with encoded frames are transmitted and (2) corresponding reception durations over which packets are received, in order to compute a slope. The congestion control module approximates the intersection of a regression line with the identity line y=x as a limit to compute a capacity estimated bitrate. In parallel, the congestion control module applies an additive-increase/multiplicative-decrease (AIMD) technique to packet-loss and Explicit Congestion Notification (ECN) feedback to derive a congestion control bitrate. The congestion control module then selects a minimum of the capacity estimated and congestion control bitrates as a final target bitrate and a minimum of the capacity estimated slope and a congestion control slope derived from the congestion control bitrate as an effective slope for determining a pacing rate for a pacer. The pacer interpolates between a dithered probe window and a reception-target window according to the effective slope to generate a per-frame send interval, and the encoder encodes frames to match the target bitrate. In addition, the pacer can delay the transmission of packets for a given frame to compensate for variations so that the last packets of the given frame are guaranteed to land before the arrival window of a next frame, yielding stable frame delivery.

At least one technical advantage of the disclosed techniques relative to the prior art is that the disclosed techniques do not require buffering packets and, therefore, do not cause playback delay when packets are being played back. Another technical improvement over prior art approaches is that the disclosed techniques enable adjustment of the send duration for each frame based on an estimated share of available network path capacity, which provides a relatively accurate estimate of network capacity and reduces queuing. The disclosed techniques also enable transmission rate control based on measured send and reception durations along with additional feedback indicating whether packet transmission should be reduced due to congestion. The additional feedback improves responsiveness in changing network conditions and enables more accurate identification of a most restrictive network bottleneck. In addition, the disclosed techniques enable alignment of transmitted frames with the display interval expected by a client device and modification of transmission timing in response to changes in frame size and delivery delay. These technical advantages represent one or more technological advancements over prior art approaches.
1. In some embodiments, a computer-implemented method for controlling network congestion comprises determining a first slope that relates (i) reception durations over which packets are received by a client device and (ii) send durations over which packets are transmitted to the client device, interpolating a first send duration over which packets are transmitted to the client device and a first reception duration over which packets are received by the client device based on the first slope to determine a second send duration, and causing one or more first packets to be transmitted over a network based on the second send duration.
2. The computer-implemented method of clause 1, further comprising computing a second slope based on one or more second reception durations over which one or more second packets were received by the client device and one or more second send durations over which the one or more second packets were transmitted to the client device, computing a third slope using a reactive rate estimation technique, wherein determining the first slope is determined as a minimum of the second slope and the third slope.
3. The computer-implemented method of clauses 1 or 2, wherein computing the second slope comprises performing one or more linear regression operations based on the one or more second reception durations and the one or more second send durations.
4. The computer-implemented method of any of clauses 1-3, wherein the third slope is computed based on a bitrate that is determined using a reactive rate estimation technique.
5. The computer-implemented method of any of clauses 1-4, wherein the interpolating is further based on a random variation to the first send duration.
6. The computer-implemented method of any of clauses 1-5, wherein the interpolating is further based on a minimum of (i) a ratio of a frame size to a target size and (ii) one.
7. The computer-implemented method of any of clauses 1-6, wherein causing the one or more first packets to be transmitted comprises delaying transmission of the one or more first packets based on a second reception duration over which one or more second packets were received by the client device.
8. The computer-implemented method of any of clauses 1-7, wherein delaying transmission of the one or more first packets is further based on a second slope that is computed based on one or more third reception durations over which one or more third packets were received by the client device and one or more third send durations over which the one or more third packets were transmitted to the client device.
9. The computer-implemented method of any of clauses 1-8, wherein causing the one or more first packets to be transmitted comprises aligning one or more last packets included in the one or more first packets based on a frame period over which the one or more first packets are received by the client device.
10. The computer-implemented method of any of clauses 1-9, wherein the one or more packets are associated with a video frame.
11. In some embodiments, one or more non-transitory computer-readable media store instructions that, when executed by at least one processor, cause the at least one processor to perform steps for controlling network congestion, the steps comprising determining a first slope that relates (i) reception durations over which packets are received by a client device and (ii) send durations over which packets are transmitted to the client device, interpolating a first send duration over which packets are transmitted to the client device and a first reception duration over which packets are received by the client device based on the first slope to determine a second send duration, and causing one or more packets to be transmitted over a network based on the second send duration.
12. The one or more non-transitory computer-readable media of clause 11, wherein the instructions, when executed by the at least one processor, further cause the at least one processor to perform the steps of computing a second slope based on one or more second reception durations over which one or more second packets were received by the client device and one or more second send durations over which the one or more second packets were transmitted to the client device, computing a third slope using a reactive rate estimation technique, wherein the first slope is determined as a minimum of the second slope and the third slope.
13. The one or more non-transitory computer-readable media of clauses 11 or 12, wherein computing the second slope comprises performing one or more linear regression operations based on the one or more second reception durations and the one or more second send durations.
14. The one or more non-transitory computer-readable media of any of clauses 11-13, wherein the third slope is computed based on a bitrate that is determined using a reactive rate estimation technique.
15. The one or more non-transitory computer-readable media of any of clauses 11-14, wherein the interpolating is further based on at least one of a random variation to the first send duration or a minimum of (i) a ratio of a frame size to a target size and (ii) one.
16. The one or more non-transitory computer-readable media of any of clauses 11-15, wherein causing the one or more first packets to be transmitted comprises delaying transmission of the one or more first packets based on a second reception duration over which one or more second packets were received by the client device.
17. The one or more non-transitory computer-readable media of any of clauses 11-16, wherein the first send duration is interpolated closer to the first send duration when the first slope is closer is one.
18. The one or more non-transitory computer-readable media of any of clauses 11-17, wherein the first send duration is interpolated closer to the first reception duration when the first slope is closer is zero.
19. The one or more non-transitory computer-readable media of any of clauses 11-18, wherein the one or more packets are associated with at least one frame of a video game.
20. In some embodiments, a system comprises a memory storing instructions, and one or more processors that are coupled to the memory and, when executing the instructions, are configured to perform the steps of determining a first slope that relates (i) reception durations over which packets are received by a client device and (ii) send durations over which packets are transmitted to the client device, interpolating a first send duration over which packets are transmitted to the client device and a first reception duration over which packets are received by the client device based on the first slope to determine a second send duration, and causing one or more packets to be transmitted over a network based on the second send duration.
1. In some embodiments, a computer-implemented method for controlling network congestion comprises computing a first slope based on one or more send durations over which one or more first packets are transmitted to a client device and one or more reception durations over which the one or more first packets are received by the client device, computing a second slope using a reactive rate estimation technique, and causing one or more second packets to be transmitted over a network based on a minimum slope selected from the first slope and the second slope.
2. The computer-implemented method of clause 1, further comprising determining a first bitrate based on the first slope and an identity line, determining a second bitrate using the reactive rate estimation technique, and encoding at least one video frame based on a minimum bitrate selected from the first bitrate and the second bitrate, wherein the one or more second packets correspond to the at least one video frame.
3. The computer-implemented method of clauses 1 or 2, further comprising computing a target frame size for the at least one video frame based on the minimum bitrate and a frame period.
4. The computer-implemented method of any of clauses 1-3, wherein computing the first slope comprises performing a linear regression based on the one or more send durations and the one or more reception durations.
5. The computer-implemented method of any of clauses 1-4, wherein computing the second slope comprises determining a bitrate using the reactive rate estimation technique, and computing the second slope based on the bitrate.
6. The computer-implemented method of any of clauses 1-5, wherein computing the second slope comprises applying the reactive rate estimation technique to at least one of packet-loss data or explicit congestion notification (ECN) feedback from the client device to determine a bitrate, and computing the second slope based on the bitrate.
7. The computer-implemented method of any of clauses 1-6, wherein causing the one or more second packets to be transmitted over the network based on the minimum slope comprises interpolating between a dithered probe window and a reception-target window based on the minimum slope to determine a send interval, and causing the one or more second packets to be transmitted over the network based on the send interval.
8. The computer-implemented method of any of clauses 1-7, wherein causing the one or more second packets to be transmitted over the network comprises delaying transmission of the one or more second packets based on the minimum slope, a maximum send duration, and a first send duration.
9. The computer-implemented method of any of clauses 1-8, wherein the reactive rate estimation technique comprises an additive-increase/multiplicative-decrease (AIMD) technique.
10. The computer-implemented method of any of clauses 1-9, wherein the reactive rate estimation technique comprises a Low Latency, Low Loss, and Scalable Throughput (L4S) technique.
11. In some embodiments, one or more non-transitory computer-readable media store instructions that, when executed by at least one processor, cause the at least one processor to perform steps for controlling network congestion, the steps comprising computing a first slope based on one or more send durations over which one or more first packets are transmitted to a client device and one or more reception durations over which the one or more first packets are received by the client device, computing a second slope using a reactive rate estimation technique, and causing one or more second packets to be transmitted over a network based on a minimum slope selected from the first slope and the second slope.
12. The one or more non-transitory computer-readable media of clause 11, wherein the instructions, when executed by the at least one processor, further cause the at least one processor to perform the steps of determining a first bitrate based on the first slope and an identity line, determining a second bitrate using the reactive rate estimation technique, and encoding at least one video frame based on a minimum bitrate selected from the first bitrate and the second bitrate, wherein the one or more second packets correspond to the at least one video frame.
13. The one or more non-transitory computer-readable media of clauses 11 or 12, wherein computing the first slope comprises performing a linear regression based on the one or more send durations and the one or more reception durations.
14. The one or more non-transitory computer-readable media of any of clauses 11-13, wherein computing the second slope comprises determining a bitrate using the reactive rate estimation technique, and computing the second slope based on the bitrate.
15. The one or more non-transitory computer-readable media of any of clauses 11-14, wherein the reactive rate estimation technique comprises at least one of an additive-increase/multiplicative-decrease (AIMD) technique or a Low Latency, Low Loss, and Scalable Throughput (L4S) technique.
16. The one or more non-transitory computer-readable media of any of clauses 11-15, wherein causing the one or more second packets to be transmitted over the network based on the minimum slope comprises interpolating between a dithered probe window and a reception-target window based on the minimum slope to determine a send interval, and causing the one or more second packets to be transmitted over the network based on the send interval.
17. The one or more non-transitory computer-readable media of any of clauses 11-16, wherein causing the one or more second packets to be transmitted over the network comprises delaying transmission of the one or more second packets based on the minimum slope, a maximum send duration, and a first send duration.
18. The one or more non-transitory computer-readable media of any of clauses 11-17, wherein the one or more packets are associated with a video frame.
19. The one or more non-transitory computer-readable media of any of clauses 11-18, wherein the one or more packets are associated with at least one frame of a video game.
20. In some embodiments, a system comprises a memory storing instructions, and one or more processors, that when executing the instructions, are configured to perform the steps of computing a first slope based on one or more send durations over which one or more first packets are transmitted to a client device and one or more reception durations over which the one or more first packets are received by the client device, computing a second slope using a reactive rate estimation technique, and causing one or more second packets to be transmitted over a network based on a minimum slope selected from the first slope and the second slope.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general-purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for controlling network congestion, the method comprising:
computing a first slope based on one or more send durations over which one or more first packets are transmitted to a client device and one or more reception durations over which the one or more first packets are received by the client device;
computing a second slope using a reactive rate estimation technique; and
causing one or more second packets to be transmitted over a network based on a minimum slope selected from the first slope and the second slope.

2. The computer-implemented method of claim 1, further comprising:
determining a first bitrate based on the first slope and an identity line;
determining a second bitrate using the reactive rate estimation technique; and
encoding at least one video frame based on a minimum bitrate selected from the first bitrate and the second bitrate, wherein the one or more second packets correspond to the at least one video frame.

3. The computer-implemented method of claim 2, further comprising computing a target frame size for the at least one video frame based on the minimum bitrate and a frame period.

4. The computer-implemented method of claim 1, wherein computing the first slope comprises performing a linear regression based on the one or more send durations and the one or more reception durations.

5. The computer-implemented method of claim 1, wherein computing the second slope comprises:
determining a bitrate using the reactive rate estimation technique; and
computing the second slope based on the bitrate.

6. The computer-implemented method of claim 1, wherein computing the second slope comprises:
applying the reactive rate estimation technique to at least one of packet-loss data or explicit congestion notification (ECN) feedback from the client device to determine a bitrate; and
computing the second slope based on the bitrate.

7. The computer-implemented method of claim 1, wherein causing the one or more second packets to be transmitted over the network based on the minimum slope comprises:
interpolating between a dithered probe window and a reception-target window based on the minimum slope to determine a send interval; and
causing the one or more second packets to be transmitted over the network based on the send interval.

8. The computer-implemented method of claim 1, wherein causing the one or more second packets to be transmitted over the network comprises delaying transmission of the one or more second packets based on the minimum slope, a maximum send duration, and a first send duration.

9. The computer-implemented method of claim 1, wherein the reactive rate estimation technique comprises an additive-increase/multiplicative-decrease (AIMD) technique.

10. The computer-implemented method of claim 1, wherein the reactive rate estimation technique comprises a Low Latency, Low Loss, and Scalable Throughput (L4S) technique.

11. One or more non-transitory computer-readable media storing instructions that, when executed by at least one processor, cause the at least one processor to perform steps for controlling network congestion, the steps comprising:
computing a first slope based on one or more send durations over which one or more first packets are transmitted to a client device and one or more reception durations over which the one or more first packets are received by the client device;
computing a second slope using a reactive rate estimation technique; and
causing one or more second packets to be transmitted over a network based on a minimum slope selected from the first slope and the second slope.

12. The one or more non-transitory computer-readable media of claim 11, wherein the instructions, when executed by the at least one processor, further cause the at least one processor to perform the steps of:
determining a first bitrate based on the first slope and an identity line;
determining a second bitrate using the reactive rate estimation technique; and
encoding at least one video frame based on a minimum bitrate selected from the first bitrate and the second bitrate, wherein the one or more second packets correspond to the at least one video frame.

13. The one or more non-transitory computer-readable media of claim 11, wherein computing the first slope comprises performing a linear regression based on the one or more send durations and the one or more reception durations.

14. The one or more non-transitory computer-readable media of claim 11, wherein computing the second slope comprises:
determining a bitrate using the reactive rate estimation technique; and
computing the second slope based on the bitrate.

15. The one or more non-transitory computer-readable media of claim 11, wherein the reactive rate estimation technique comprises at least one of an additive-increase/multiplicative-decrease (AIMD) technique or a Low Latency, Low Loss, and Scalable Throughput (L4S) technique.

16. The one or more non-transitory computer-readable media of claim 11, wherein causing the one or more second packets to be transmitted over the network based on the minimum slope comprises:
interpolating between a dithered probe window and a reception-target window based on the minimum slope to determine a send interval; and
causing the one or more second packets to be transmitted over the network based on the send interval.

17. The one or more non-transitory computer-readable media of claim 11, wherein causing the one or more second packets to be transmitted over the network comprises delaying transmission of the one or more second packets based on the minimum slope, a maximum send duration, and a first send duration.

18. The one or more non-transitory computer-readable media of claim 11, wherein the one or more packets are associated with a video frame.

19. The one or more non-transitory computer-readable media of claim 11, wherein the one or more packets are associated with at least one frame of a video game.

20. A system, comprising:
a memory storing instructions; and
one or more processors, that when executing the instructions, are configured to perform the steps of:
computing a first slope based on one or more send durations over which one or more first packets are transmitted to a client device and one or more reception durations over which the one or more first packets are received by the client device,
computing a second slope using a reactive rate estimation technique, and
causing one or more second packets to be transmitted over a network based on a minimum slope selected from the first slope and the second slope.
